(19) United States
(12) Patent Application Publication
(10) Pub. No.: US 2012/0321324 A1
(43) Pub. Date: Dec. 20, 2012

(54) Architecture of 4-ASK Transmitter

(75) Inventors: Jianjun Yu, Basking Ridge, NJ (US); Ming-Fang Huang, Atlanta, GA (US)

(73) Assignee: NEC Laboratories America, Inc., Princeton, NJ (US)

(21) Appl. No.: 13/495,368

(22) Filed: Jun. 13, 2012

Related U.S. Application Data
(60) Provisional application No. 61/497,982, filed on Jun. 17, 2011.

(51) Int. Cl. H04B 10/04

(52) U.S. Cl. 398/186

(57) ABSTRACT

The present method is for generating a 4-level optical signal and it includes providing a continuous wave CW optical source; modulating the CW optical source with a first intensity modulator driven by a binary electrical signal a n Gbits/s to generate an optical signal; employing a second intensity modulator as a pulse carving modulator that is driven by an RF signal at n GHz thereby generating a 4 level optical signal for subsequent detection by a receiver.

This application claims the benefit of U.S. Provisional Application No. 61/497,982, entitled “Architecture of 4-ASK Transmitter”, filed Jun. 17, 2011, of which the contents are incorporated herein by reference.

### BACKGROUND OF THE INVENTION

The present invention relates generally to optical communications and more particularly to an architecture for a 4-ASK transmitter.

HIGH NUMBER level modulation format can be used to increase the spectral efficiency. Relative to BPSK modulation, four-level modulation can be used to improve the spectral efficiency up to 100%. For four-level optical signal generation, the regular scheme is to use electrical four-level signals to drive an intensity modulator to generate optical four-level signal. Usually, people use one electrical coupler to combine two different level binary phase-shift key BPSK signal to get the four-level electrical signal. However, due to various reflections from the connectors, electrical cables, and the coupler, it is very difficult to generate a high-quality and high-speed four-level electrical signal by using discrete components. Recently, we invented a new scheme to generate multilevel electrical signal by electrical-optical-electrical-optical scheme, but this scheme is quite complicate, and it is difficult to use in a real system.

Accordingly, there is a need for a new and simple scheme to generate a 4-level optical signal.

### BRIEF SUMMARY OF THE INVENTION

The present invention is a method for generating a 4-level optical signal and it includes providing a continuous wave CW optical source; modulating the CW optical source with a first intensity modulator driven by a binary electrical signal a n Gbits/s to generate an optical signal; employing a second intensity modulator as a pulse carving modulator that is driven by an RF signal at n GHz thereby generating a 4 level optical signal for subsequent detection by a receiver.

These and other advantages of the invention will be apparent to those of ordinary skill in the art by reference to the following detailed description and the accompanying drawings.

### BRIEF DESCRIPTION OF THE DRAWINGS

FIG. 1 is a diagram of an exemplary 4-level optical signal generation and detection, in accordance with the invention;

FIG. 2 shows a block diagram highlighting aspects of the 4-level optical signal generation and detection, in accordance with the invention.

### DETAILED DESCRIPTION

The present invention is directed to optical signal generation that uses an intensity modulator to generate a binary phase modulation signal, then employ another synchronized intensity modulator driven by a clock signal to generate a 4 level optical signal.

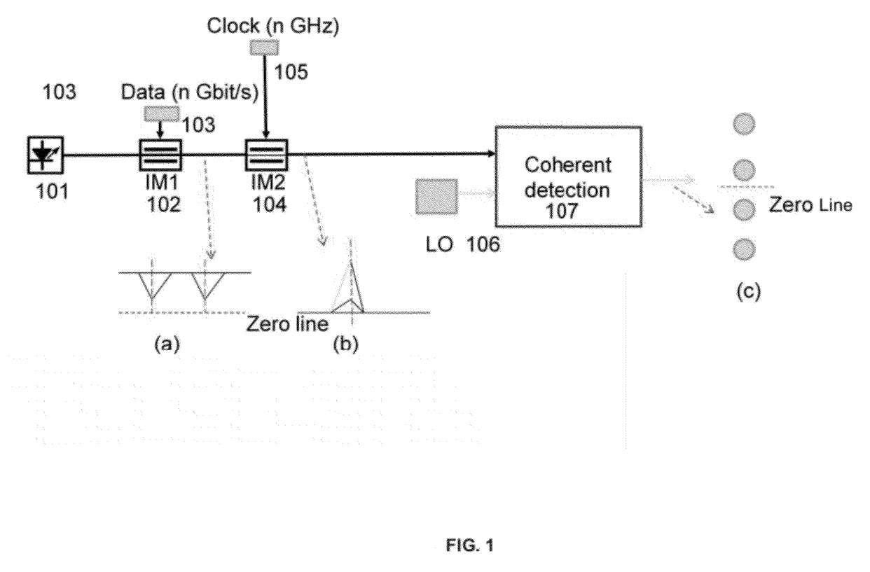

Referring to FIG., there is shown a configuration of a 4-level optical signal generation and detection. A single-mode continuous wave CW lightwave 101 is modulated by an intensity modulator IM 102 that is driven by a binary electrical signal 103 at n Gbit/s. This binary electrical signal should be pre-coded in order to recover at the receiver side. This binary electrical signal can also be decoded at the receiver side. This intensity modulator IM 102 should be biased at the null point to generate phase modulation of the optical signal. After this IM modulator 102, an optical waveform, as shown in inset (a) of FIG. 1, can then be generated. We can see that one dark optical signal is generated after this intensity modulator. This intensity modulator can be a single driver or dual-driver modulator. After that, a return-to-zero RZ shape with a small duty cycle after pulse carving modulator (104) is employed. The second intensity modulator (104) is driven by a radio frequency RF signal at n GHz. The second modulator 104 should be used to modulate the dark signal. It means that we should modulate the optical signal at the time slot labeled by the red line as shown in inset (a) in FIG. 1. Component 105 is a radio frequency RF signal or clock source. After the second intensity modulator 104, an optical signal as shown in inset (b) in FIG. 1 will be generated. This four-level optical signal will be detected by a regular optical coherent detection system. It usually contains one optical local oscillator 106 and a 90 degree hybrid and optical receiver 107.

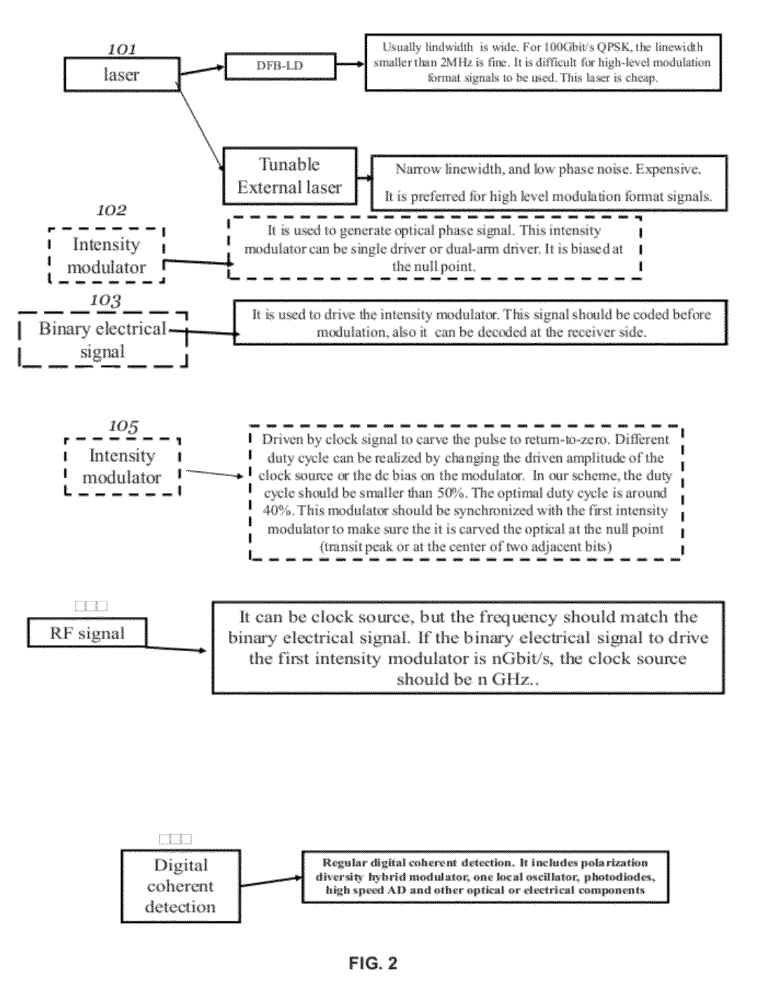

Referring to FIG. 2, the diagram highlights key aspects of the inventive OBM-OFDM optical signal generation and direct detection.

The continuous wave laser source 101 can be either a distributed feedback laser diode DFB-LD or tunable external laser source. For a DFB-LD the line width is usually wide. For a 100 Gbit/s QPSK a line width smaller than 2 MHz is fine. It is difficult for high-level modulation format signals to be used. This laser source is cheap. A tunable external laser exhibits a narrow line width, and low phase noise. Although the tunable external laser source is expensive, it is preferred for high level modulation format signals.

The intensity modulator 102 used to generate an optical phase can be a single driver or dual-arm driver which is biased at the null point. The binary electrical signal 103 used to drive the intensity modulator should be coded before modulation and it can then be decoded at the receiver side.

The second intensity modulator 105 is driven by a clock signal to carve the pulse to return-to-zero. A different duty cycle can be realized by changing the driven amplitude of the clock source or the dc bias on the modulator. In the present invention, the duty cycle preferably should be smaller than 50%. The optimal duty cycle is around 40%. This modulator should be synchronized with the first intensity modulator to make sure the it carves the optical at the null point (transit peak or at the center of two adjacent bits).

The radio frequency RF signal 106 can be a clock source, but the frequency should match the binary electrical signal. If the binary electrical signal to drive the first intensity modulator is n Gbit/s, the clock source should be n GHz.

The digital coherent detection 107 is a regular digital coherent detection. It includes a polarization diversity hybrid modulator, one local oscillator, photodiodes, high speed AD and other optical or electrical components (not shown).

From the foregoing, it can be appreciated that inventive 4-level optical signal generation is simpler and more stable than configurations already known or taught by others

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for generating a 4-level optical signal, said method comprising the steps of:
providing a continuous wave CW optical source;
modulating the CW optical source with a first intensity modulator driven by a binary electrical signal a n Gbits/s to generate an optical signal;
employing a second intensity modulator as a pulse carving modulator that is driven by an RF signal at n GHz thereby generating a 4 level optical signal for subsequent detection by a receiver.

2. The method of claim 1, wherein said binary electrical signal is precoded to enable recovery of information at a receiver.

3. The method of claim 1, wherein said first intensity modulator is biased at a null point to generate a phase modulation optical signal.

4. The method of claim 1, wherein said first intensity modulator can be a single driver or dual driver modulator.

5. The method of claim 1, wherein said second intensity modulator modulates a dark signal
